(19) United States
(12) Patent Application Publication
(10) Pub. No.: US 2019/0227957 A1
(43) Pub. Date: Jul. 25, 2019

(54) METHOD FOR USING DEALLOCATED MEMORY FOR CACHING IN AN I/O FILTERING FRAMEWORK

(71) Applicant: VMware, Inc., Palo Alto, CA (US)

(72) Inventors: Abhishek SRIVASTAVA, Palo Alto, CA (US); Saksham JAIN, Palo Alto, CA (US); Nikolay ILDUGANOV, Palo Alto, CA (US); Christoph KLEE, Issaquah, WA (US); Ashish KAILA, Palo Alto, CA (US)

(73) Assignee: VMware, Inc., Palo Alto, CA (US)

(21) Appl. No.: 15/879,389

(22) Filed: Jan. 24, 2018

(51) Int. Cl. G06F 13/16; G06F 12/06; G06F 9/455

(52) U.S. Cl. CPC G06F 13/1642; G06F 12/063; G06F 9/45558; G06F 2009/45583; G06F 2212/152; G06F 2212/657; G06F 2009/45579; G06F 2212/1016

(57) ABSTRACT

Techniques are disclosed for filtering input/output (I/O) requests in a virtualized computing environment. In some embodiments, a system stores first data in a page of memory, where after the first data is stored in the page of memory, the page of memory is free for allocation to a first memory consumer (e.g., an I/O filter instantiated in a virtualization layer of the virtualized computing environment) and a second memory consumer. The first memory consumer retains a reference to the page of memory. The first memory consumer receives a data request from a virtual computing instance. Based on the data request, the first memory consumer retrieves the first data using the reference to the page of memory. After retrieving the first data, the system returns the first data to the virtual computing instance. While the first memory consumer has the reference to the page of memory, the page of memory can be allocated to the second memory consumer without notifying the first memory consumer.

### BACKGROUND

Computing systems typically allocate memory using a regime that guarantees the continued availability of the allocated memory. If a memory consumer requests an allocation of memory and there is sufficient free memory to satisfy the request, then the request is granted. The memory consumer may subsequently use the allocated memory until the memory consumer process terminates or explicitly releases the allocated memory. Typically, if sufficient free memory is not available to accommodate the memory allocation request, then the request is denied. Certain memory consumers are tolerant of being denied a memory allocation request, but some memory consumers fail if they are denied a memory allocation request. To avoid insufficient memory, many computing systems are configured to operate with a significant reserve of memory that purposefully remains idle.

Managing memory in a virtualized computing environment can be particularly challenging. For example, in a conventional virtual machine (VM) environment, proper execution of each VM depends on an associated virtual machine monitor (VMM) having sufficient memory. The VMM may request a memory allocation during normal operation. If a host system has insufficient memory for the VMM at some point during VM execution, then the VMM is forced to operate the VM with reduced capability or possibly terminate the VM. If the average amount of idle memory falls below a predetermined threshold, then the host system may be reconfigured to reestablish a certain minimum amount of idle memory. Memory reallocation may be used along with process migration to rebalance VM system loads among host systems, thereby increasing idle memory on the host system encountering memory pressure. While maintaining an idle memory reserve serves to avoid failures, this idle memory represents a potentially expensive unused resource.

Also, as part of VM operation, VMs consume memory by reading and writing data with input/output (I/O) requests to the VMM. In addition to consuming memory, I/O requests require processing resources to read or write the requested data to or from memory. Servicing I/O requests from storage devices (e.g., a disk) is slow and inefficient, and the processing time and bandwidth required to service the I/O requests increases processing latency and delay.

### SUMMARY

Techniques described below use deallocated memory to cache data associated with I/O requests (“I/O request data”) processed in a virtualized computing environment. In some embodiments, a virtualized computing environment includes a virtualization layer with a VMM and a filter for processing I/O requests between VMs and virtual storage implemented on the computer system. Such a filter is referred to herein as an I/O filter.

An I/O request from a VM includes any request by a VM to read or write data. In response to receiving from a VM a request for data, in addition to retrieving the requested data from its disk location, the I/O filter stores (e.g., caches) the requested data in a deallocated page of free memory available to the virtualization layer, and retains a reference to the data for quick future access. That is, I/O request data are stored in memory that is not dedicated solely to the I/O filter. In some embodiments, the I/O filter caches data associated with all I/O requests in this manner, or optionally, caches data only for I/O requests that meet some criteria, such as I/O requests for data that are likely to be requested again by the VM and/or by other VMs running on the system.

When the I/O filter receives another request for the same data (either from the same VM or a different VM), rather than retrieving the data from the data's main disk location, the I/O filter retrieves the data from the free memory location using the stored reference. In this way, the I/O filter can quickly obtain commonly used data without having to retrieve the data from its main disk location and without taking memory away from the virtualization layer. This allows for faster I/O processing, as the data does not have to be retrieved from a slower memory source (e.g., a disk or storage system). It also reduces memory requirements for the I/O filter, leaving more memory available for the virtualization layer to use for other processes, such as running additional VMs or maintaining existing VMs that require additional memory. Caching I/O request data in free memory available to the virtualization layer also increases memory utilization rates and reduces the need to continually monitor and scale the size of memory allocated to the I/O filter based on the memory demands of other competing memory consumers and the demands of the I/O filter itself. Furthermore, dedicating a separate flash device solely to the I/O filter requires integrating the flash device into the virtualized system. Caching I/O request data in free memory available to the virtualization layer, rather than in a dedicated flash device, eliminates the overhead required to integrate the flash device into the virtualized system and provides an easier way to manage the I/O filter cache.

### BRIEF DESCRIPTION OF THE DRAWINGS

FIG. 1 depicts a block diagram of a computer system according to some embodiments.

FIG. 2A depicts a memory consumer requesting pages of memory according to some embodiments.

FIG. 2B depicts the memory consumer having pages of allocated memory according to some embodiments.

FIG. 2C depicts the memory consumer releasing pages of memory according to some embodiments.

FIG. 2D depicts the memory consumer retaining a reference to a page of deallocated memory according to some embodiments.

FIG. 3 depicts a block diagram of a computer system including an I/O filter with a dedicated cache according to some embodiments.

FIG. 4A-4B depicts a block diagram of a computer system including an I/O filter that uses deallocated memory as cache according to some embodiments.

FIG. 5 depicts a flow diagram of a process for using deallocated memory as cache for an I/O filter according to some embodiments.

### DETAILED DESCRIPTION

### A. System Architecture

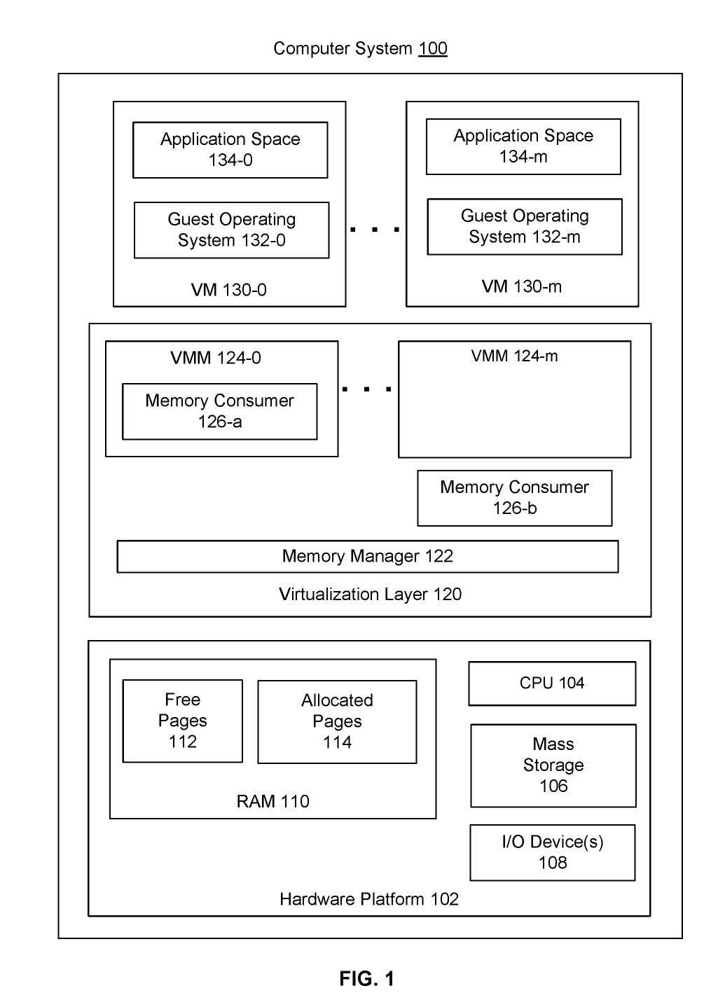

FIG. 1 depicts a block diagram of an exemplary computer system 100 in which embodiments of the present disclosure may be implemented. The computer system 100 is optionally constructed as a desktop, laptop, or server grade hardware platform 102, including different variations of the x86 architecture platform or any other technically feasible architecture platform. Hardware platform 102 includes a central processing unit (CPU) 104, random access memory (RAM) 110 (such as DRAM, SRAM, and NVRAM (e.g., flash memory and solid-state drives (SSDs)), mass storage 106 (such as a hard disk drive), and I/O device(s) 108 (such as a mouse, touchpad, touchscreen, and keyboard). RAM 110 is organized as pages of memory. A “page” is generally a contiguous block of memory of a certain size where computer system 100 manages units or blocks of memory the size of a page. Traditionally, pages in a system have uniform size or segment (e.g., 4096 bytes). A page is generally the smallest segment or unit of translation available to an operating system (OS). Accordingly, a page is a definition for a standardized segment of data that can be moved and processed by computer system 100.

Computer system 100 includes a virtualized computing environment. In the illustrated embodiment, virtualization layer 120 is installed on top of hardware platform 102 to support a VM execution space, within which at least one VM 130-0 is instantiated for execution. Optionally, additional VM instances 130 coexist under control of the virtualization layer 120, which is configured to map the physical resources of hardware platform 102 (e.g., CPU 104, RAM 110, etc.) to a set of corresponding “virtual” (emulated) resources for each VM 130. The virtual resources are provided by a corresponding VMM 124, residing within the virtualization layer 120. The virtual resources optionally function as the equivalent of a standard x86 hardware architecture, such that any x86 supported operating system, e.g., Microsoft Windows, Linux, Solaris x86, NetWare, FreeBSD, etc., may be installed as a guest operating system 132. The guest operating system 132 facilitates application execution within an application space 134. In some embodiments, the virtualization layer 120 comprises a hypervisor within VMware® vSphere® virtualization product, available from VMware, Inc. of Palo Alto, Calif. In some embodiments, a host operating system is installed between the virtualization layer 120 and hardware platform 102. In such embodiments, the virtualization layer 120 operates above an abstraction level provided by the host operating system. It should be recognized that the various terms, layers, and categorizations used to describe the components in FIG. 1 may be referred to differently without departing from their functionality or the spirit or scope of the disclosure.

The virtualization layer 120 includes a memory manager 122 configured to allocate pages of memory residing within RAM 110 to memory consumers 126. A memory consumer 126 optionally resides within a VMM 124 or any other portion of the virtualization layer 120. In some embodiments, the memory consumer 126 resides within any technically feasible portion of the computer system 100, such as a kernel space of an operating system installed between the virtualization layer 120 and hardware platform 102. In some embodiments, the memory consumer 126 resides within a non-kernel execution space, such as in a user space. In some embodiments, the memory manager 122 resides within the kernel of the operating system. In some embodiments, memory manager 122 automates storage management workflows and provides access to memory based on predefined storage policies.

The pages of memory within RAM 110 are generally organized as allocated pages 114 and free pages 112. The allocated pages 114 are pages of memory that are reserved for use by a memory consumer 126. The free pages 112 represent a free page pool comprising pages of memory that are free for allocation to a memory consumer 126.

In a conventional memory management regime, each free page is presumed to not store presently valid data, and each allocated page is reserved by a memory consumer regardless of whether the page presently stores valid data. Furthermore, in a conventional cache, associated pages are allocated exclusively to the cache, and only authorized users, such as the system component to which the pages are allocated, may access these pages of the cache.

By contrast, according to a memory management regime that uses deallocated memory as described in greater detail below, pages of deallocated memory are not allocated exclusively to a memory consumer, and deallocated memory pages may be accessed by any appropriately configured memory consumer, affording a memory management regime with greater flexibility and greater usability by more memory consumers. In addition, the conventional cache maintains its own list of freeable memory pages or has to be at least notified when a memory page is no longer free. A memory management regime that uses deallocated memory as described herein does not require such notification and may be implemented without the associated overhead.

### B. Deallocated Memory Utilization

In some embodiments, a memory management regime includes pages of memory, where a page of memory may be characterized as allocated, idle, or referenced. Allocated pages 114 are reserved in a conventional manner. However, free pages 112 are deallocated pages that are categorized as being either idle or referenced. Idle pages have been released from an associated memory consumer with no expectation of further use by the memory consumer. A referenced page has been returned to the set of free pages 112 from an associated memory consumer that retains a reference to the returned page in accordance with an expectation that the referenced page may be beneficially accessed at a later time. Both idle and referenced pages are available to be allocated and become allocated pages 114.

A memory consumer that retains a reference to deallocated memory may, at any time, lose access to data stored within one or more referenced pages of deallocated memory. In some embodiments, a memory management regime accounts for the potential loss of data in the referenced pages of deallocated memory by ensuring that the memory consumer can restore or retrieve data associated with lost pages of memory from a reliable source, or continue properly without the lost pages.

In some embodiments, referenceable pages are allocated according to conventional techniques but are returned to the free page pool. In some examples, a memory consumer requests an allocation of at least one page of memory from the memory manager 122. The memory manager 122 then grants the allocation request. At this point, the memory consumer fills the page of memory, optionally marks the page as read-only, and subsequently returns the page to the memory manager 122 as a deallocated page of memory. The memory manager 122 then adds the page of memory back to the free page pool. The memory consumer retains a reference to the deallocated page of memory for later access. If the referenced page of memory, now among the free pages 112, has not been reallocated, then the memory consumer may access the page of memory using the retained reference to the page. In certain embodiments, the memory consumer requests that the memory manager 122 reallocate the referenced page of memory to the memory consumer, for example, if the memory consumer needs to write new data into the referenced page of memory. After the write, the memory consumer releases the referenced page of memory back to the free page pool.

Various techniques for validating that the data stored in a referenced page of deallocated memory is still valid are described, for example, in U.S. Patent Application Publication No. 2013/0205113, which is hereby incorporated by reference. In some embodiments, a generation number is assigned to a page and incremented each time the page is allocated. A memory consumer determines whether the data in a referenced page is still valid based on whether the current generation number matches the generation number associated with the desired data. When a specific memory consumer reads a particular referenced page of memory, if the generation number saved by the memory consumer matches the current generation number associated with the page of memory, then it is determined that the page of memory was not allocated to another memory consumer and data stored within the page of memory is valid for the specific memory consumer. However, if the saved generation number does not match the current generation number, then it is determined that the page of memory was allocated to another memory consumer and the data stored within the page of memory is not valid for the specific memory consumer. Techniques using referenced pages of deallocated memory may also order the pages so that released pages to which a memory consumer retains a reference are placed at the back of the list of free pages, and therefore less likely to be used by others prior to being referenced by the memory consumer.

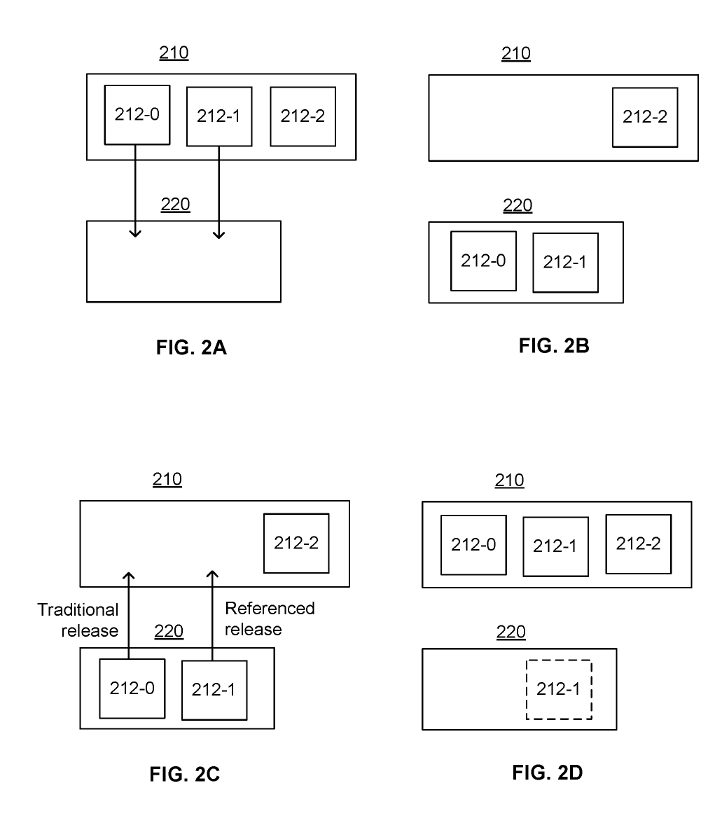

FIGS. 2A-2D depict an exemplary embodiment of allocating a page of memory, releasing the page, and retaining a reference to the page.

FIG. 2A depicts a memory consumer 220 requesting pages of memory 212-0 and 212-1. Upon receiving an allocation request from the memory consumer 220, the memory manager 122 of FIG. 1 allocates pages of memory 212-0 and 212-1 to the memory consumer 220. The two pages of memory 212-0 and 212-1 are allocated from a block of free memory 210. The memory consumer 220 receives references to pages of memory 212-0 and 212-1 to access the pages of memory 212. Each reference optionally includes a pointer to a location in memory for the corresponding page of memory 212.

FIG. 2B depicts the memory consumer 220 having pages of allocated memory 212-0 and 212-1. FIG. 2C depicts the memory consumer 220 releasing pages of memory 212-0 and 212-1 to free memory 210. A traditional release is applied to page 212-0 since the memory consumer 220 needs no further access to the page 212-0. A referenced release is applied to page 212-1 since the memory consumer 220 may benefit from further access to the page 212-1. FIG. 2D depicts memory consumer 220 retaining a reference 212-1′ to the page of memory 212-1. In some embodiments, retaining reference 212-1′ to page 212-1 includes storing reference 212-1′, and maintaining storage of reference 212-1′ after corresponding page 212-1 is released by memory consumer 220 and/or deallocated from memory consumer 220. For example, memory consumer 220 can store reference 212-1′ in memory allocated to memory consumer 220, where the memory at which reference 212-1′ is stored remains allocated to memory consumer 220 after corresponding page 212-1 is released by memory consumer 220 and/or deallocated from memory consumer 220.

In some embodiments, free memory 210 is an ordered list of free pages and may be implemented using any technically feasible list data structure. In some embodiments, the page 212-0 is added to a head of the list and may be first in line to be reallocated by the memory manager 122 since the memory consumer 220 needs no further access to the page 212-0. Conversely, the page 212-1 is added to a tail of the list because reallocating the page 212-1 should be avoided if possible, and the tail of the list represents the last possible page 212 that may be allocated from free memory 210. Other referenced pages may be added behind page 212-1 over time, thereby increasing the likelihood that the page 212-1 will be reallocated. However, placing referenced pages at the tail 213 of the list establishes a low priority for reallocation of the referenced pages, thereby increasing the likelihood that a given referenced page will be valid for use when an associated memory consumer attempts access.

### C. I/O Requests

In order to operate, VMs read and write data to and from memory using I/O requests. In some examples, I/O requests include networking I/O commands and storage I/O commands, although other I/O commands are contemplated. I/O requests include, for example, a READ request to receive data from storage and a WRITE request to write data to storage. Servicing an I/O request includes receiving a request to read or write data as well as any processing of the request and providing a response thereto (e.g., receiving a request to read data from particular sectors as well as returning the data read therefrom). For example, as part of servicing an I/O request, the requesting VM receives confirmation that the data has been successfully written to storage. In some embodiments, a computer system (e.g., 100) includes a file system layer that translates client (e.g., VM) I/O requests directed to files into I/O commands that specify logical block addresses (LBAs). These I/O commands are communicated via a block-level interface (e.g., SCSI, ATA, etc.) to a controller (e.g., memory manager 122), which translates the LBAs into physical block addresses (PBAs) corresponding to the physical locations where the requested data is stored and executes the I/O commands against the physical block addresses. Depending on the number of requests and the data requested, servicing the I/O requests can consume significant processing resources, resulting in latency and processing delays.

### D. I/O Filtering

In some embodiments, logic is provided for filtering I/O requests. In some embodiments, filtering an I/O request includes manipulating requested data prior to reading or writing the data. In some embodiments, filtering an I/O request includes analyzing the request to determine whether the request can be serviced more efficiently. For example, a filter can be used to encrypt/decrypt I/O data before the data is written/read. Filtering also allows a user to implement data replication policies, e.g., on a VM level, to provide redundancy and improve system reliability. Optionally, an I/O filter determines whether to complete, fail, pass, or defer an I/O request. For example, a blocking operation, such as sending data over a network, that blocks other operations affects the I/O operations per second (IOPS) of a virtual disk, since the virtual disk would not be able to process any further I/Os until the blocking operation completes. Accordingly, in some examples, an I/O filter will defer an I/O request if the request requires an operation that blocks other operations in order to allow other I/O requests to get processed first. Furthermore, as described in greater detail below, filtering I/O requests allows a virtualized system to cache commonly requested data in a way that the data can be accessed quickly and that reduces request processing latency, compared to retrieving data from a storage device.

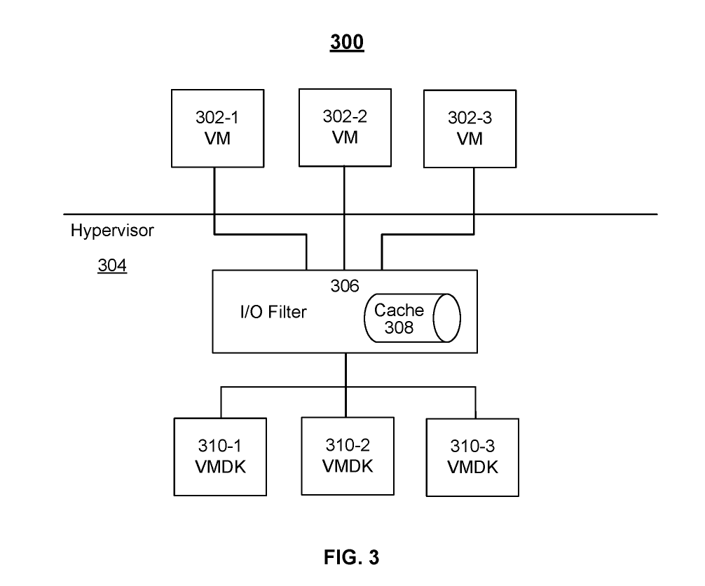

FIG. 3 depicts a block diagram of an exemplary computer system 300 implementing an I/O filter 306. In computer system 300, I/O filter 306 and VMs 302 are instantiated for execution (e.g., in virtualization layer 120 in FIG. 1). Computer system 300 also includes virtual disks 310, corresponding to respective VMs 302.

Computer system 300 includes a hypervisor 304 that launches and runs VMs 302. Hypervisor 304, in part, manages hardware (e.g., hardware platform 102) to properly allocate computing resources (e.g., processing power, random access memory, etc.) for each VM 302. Furthermore, hypervisor 304 provides access to storage resources (e.g., from mass storage 106) located in hardware (e.g., hardware platform 102) for use as storage for virtual disks 310 (or portions thereof) and other related files that may be accessed by VMs 302. In some embodiments, vSphere® Hypervisor from VMware, Inc. is installed as hypervisor 304 and vCenter® Server from VMware, Inc. is used as a virtualization management platform. Optionally, hypervisor 304 initially configures each VM 302 to have specific storage requirements for its respective virtual disk 310 depending on the intended use (e.g., capacity, availability, IOPS, etc.) of the respective VM, and allocates physical storage resources (e.g., from mass storage 106) for each virtual disk 310.

VMs 302 in computer system 300 make I/O requests to virtual disks 310, and I/O filter 306 processes the I/O requests. In the illustrated embodiment, I/O filter 306 executes inside hypervisor 304 (e.g., within virtualization layer 120 or within a specific VMM 124), as opposed to within a VM 302. I/O filter 306 optionally operates in user space of the host computer system 300 (e.g., the memory area where application software executes), rather than in kernel space so as not to affect the stability of the underlying host operating system running on computer system 300.

In some embodiments, I/O filter 306 is implemented via a defined framework (e.g., vSphere APIs for I/O Filtering (VAIO) from VMware, Inc.). An I/O filter framework allows third parties, such as storage providers and/or network providers, to provide logic (e.g., as user space “plugins”) for processing particular I/O requests. Providing a common framework for I/O filtering allows for every filter to operate in a more constrained environment (e.g., each filter uses a common set of API's). A common framework also makes the I/O filters easier to debug than filters that may be implemented without a common set of interfaces. A common framework also can be configured so that a bug in an I/O filter does not bring down the entire system, but only affects the VM associated with the request that causes the error.

I/O filter 306 optionally intercepts all I/O requests from VMs 302 to virtual disks 310 such that an I/O command is not issued or I/O data is not committed to disk without being processed by I/O filter 306. Optionally, I/O filter 306 includes multiple filters (or sub-filters) that perform different processing of the I/O requests. In some embodiments, the multiple filters are applied in series, parallel, or a combination thereof. In some embodiments, VMs 302 are all associated with a single VMM within hypervisor 304. Alternatively, in some embodiments, different VMs 302 are associated with different VMMs within hypervisor 304. Accordingly, depending on the embodiment, I/O filter 306 processes I/O requests from only VMs associated with a specific VMM or from VMs across multiple VMMs.

As mentioned above, I/O filter 306 improves the speed and efficiency with which hypervisor 304 services I/O requests from VMs 302 by caching data associated with I/O requests so that the data can be accessed quickly for future requests in order to increase the TOPS available, reduce latency, and/or increase hardware utilization rates. For example, I/O filter 306 can cache I/O data emanating from different guests (e.g., VMs) on the same host in order to quickly reuse data read or written by one guest in response to a request for the same data from a different guest.

In the embodiment depicted in FIG. 3, I/O filter 306 stores data associated with I/O requests from VMs 302 in cache memory 308. Exemplary I/O data include data that a VM writes to memory and/or data that a VM reads from memory. Cache memory 308 is located on the host computer of computer system 300 and is dedicated solely for use by I/O filter 306. Cache memory 308 is optionally a large cache created by hypervisor 304 on a flash device (e.g., an SSD). Although cache memory 308 is created by hypervisor 304, I/O filter 306 manages operation of cache memory 308. In some embodiments, I/O request data are cached by implementing I/O filter 306 as a single daemon on hypervisor 304 that caches I/O data and relays them back to a VM 302 in the case that a particular I/O request has been seen before. In some embodiments, I/O data is stored according to a policy or criteria associated with I/O filter 306 (e.g., cache all I/O requests, cache I/O requests deemed likely to be reused, either by the same VM or a different VM, etc.).

In some embodiments, prior to receiving I/O requests from VMs 302, computer system 300 “warms up” cache memory 308 by populating cache memory 308 with commonly used data. For example, VMs that boot the same operating system (e.g., Windows OS) will access the same blocks of memory that contain the files required to boot the operating system. Accordingly, computer system 300 optionally populates cache 308 with the files required to boot the operating system so that the next time a VM 302 starts and requests the files required to boot the operating system, I/O filter 306 retrieves the files from cache 308 instead of from the main memory.

As mentioned above, cache memory 308 in the embodiment of computer system 300 depicted in FIG. 3 is completely controlled by I/O filter 306. That is, cache memory 308 cannot be used as a regular virtual datastore (e.g., a Virtual Machine File System (VMFS) from VMware, Inc.) by other components of computer system 300 (e.g., by hypervisor 304). Furthermore, since cache memory 306 is managed by I/O filter 306 outside of virtual disks 310 managed by hypervisor 304 (which also handles other memory resource allocation), managing cache memory 308 is an additional burden on users implementing I/O filter 306.

### E. Deallocated Memory for I/O Filtering

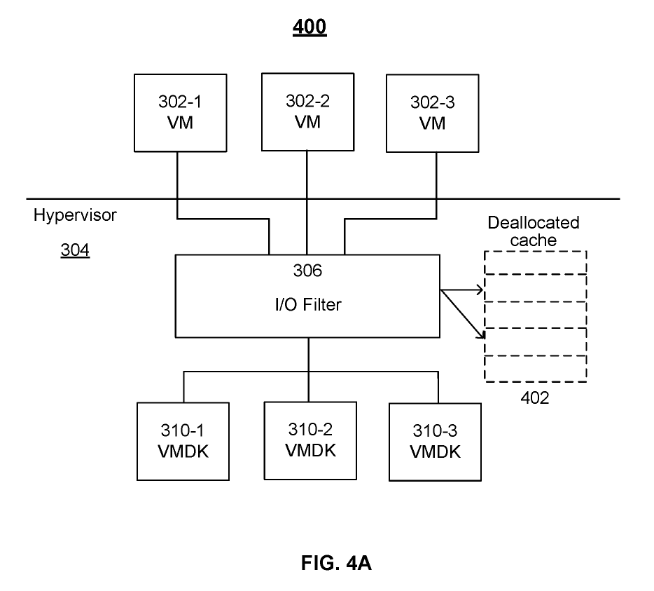

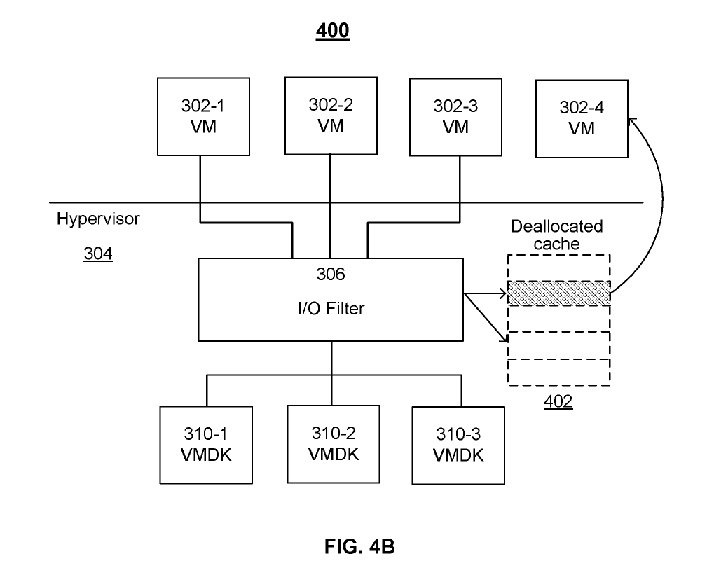

FIG. 4A illustrates an exemplary embodiment of a computer system 400 that uses deallocated memory to cache I/O request data. Similar to computer system 300 described above with reference to FIG. 3, computer system 400 includes VMs 302, hypervisor 304, I/O filter 306, and virtual disks 310. In contrast to computer system 300, computer system 400 includes deallocated memory (e.g., deallocated cache 402) that I/O filter 306 uses to cache data associated with I/O requests between VMs 302 and virtual disks 310. Deallocated cache 402 includes non-allocated (e.g., free) memory available to hypervisor 304 (e.g., deallocated memory in userspace). In some embodiments, deallocated cache 402 includes a non-allocated portion of an SSD on computer system 400 (e.g., the host). Optionally, deallocated cache 402 is a non-allocated portion of one or more virtual disks 310.

I/O filter 306 receives an I/O request from a VM 302, caches data associated with the I/O request in a free page of non-allocated memory in deallocated cache 402, and retains a reference to the page, as described above with respect to FIGS. 2A-2D. When I/O filter 306 subsequently receives the same I/O request (or a request for the same data) at a later time (e.g., from the same VM or a different VM on the same host), I/O filter 306 retrieves the request from deallocated cache 402 using the retained reference. Retrieving the requested data from deallocated cache 402 using the retained reference provides even faster and more efficient access to the I/O request compared to retrieving the data from cache memory 308 in computer system 300. Storing and retrieving the requested data using deallocated cache 402 also allows the data to be cached without dedicating memory resources solely to I/O filter 306, which reduces the amount of memory available to hypervisor 304 for other applications and increases memory utilization rates.

In the event that the cached I/O request is no longer valid (e.g., the memory location at which the I/O data was stored has been allocated to another memory consumer or populated with different data), I/O filter 306 processes the I/O request with data from a main storage location (e.g., mass storage 106). Various techniques for determining whether or not the data cached in deallocated cache 402 is still valid, prioritizing the pages within deallocated cache 402 to reduce the likelihood that data will be invalid, and how to deal with invalid data, are described, for example, in U.S. Patent Application Publication No. 2013/0205113. On average, however, the efficiency gained by quickly referring to data stored in deallocated cache 402 that is still valid outweighs the inefficiency resulting from the instances in which the data is no longer valid.

In some embodiments, computer system 400 does not include an SSD or flash memory for caching I/O request data (e.g., I/O filter 306 caches I/O request data exclusively with deallocated cache 402 instead of a flash device). Compared to providing an additional flash device dedicated solely to I/O filter 306, deallocated cache 402 provides an easier way to manage caching I/O request data since there is no additional flash device that needs to be formatted according to the requirements of the virtualized system (e.g., Virtual Flash File System (VFFS) in ESXi from VMware, Inc.), integrated into the virtualized system, and managed by the virtualized system. In some embodiments, computer system 400 implements a multi-tier I/O data caching scheme that incorporates both deallocated memory (e.g., deallocated cache 402) and, e.g., flash memory dedicated solely to I/O filter 306. In such embodiments, I/O filter 306 uses a flash device as a layer in the cache hierarchy, in addition to deallocated cache 402. For example, a relatively small SSD is optionally pre-populated with commonly used files (e.g., OS boot up files, as discussed above) and deallocated cache 402 is used to cache data associated with received I/O requests. Furthermore, in some embodiments in which computer system 400 relies solely on deallocated cache 402 for caching I/O data, computer system 400 pre-populates deallocated cache 402 with commonly used files, as described above.

As mentioned, in addition to providing faster performance, caching I/O data using deallocated cache 402 provides a more flexible design and reduces the memory resources dedicated solely for the I/O filter, which frees up memory resources for other applications and increases memory utilization rates. Unlike flash memory cache 308 in computer system 300 described above with respect to FIG. 3, the memory available to hypervisor 304 that is used for the I/O filter cache (e.g., deallocated cache 402) can be reallocated by hypervisor 304 for other applications without notifying I/O filter 306.

FIG. 4B illustrates an example in which hypervisor 304 uses a portion of deallocated cache 402 to initiate new VM 302-4. Since deallocated cache 402 is free for hypervisor 304 to use, hypervisor 304 simply allocates a portion of the free memory to new VM 302-4. In contrast, depending on the memory reallocation policy implemented in computer system 300, hypervisor 304 in computer system 300 may not be permitted to reclaim a portion of cache memory 308 to use for a new VM. And even if computer system 300 does permit reallocation of cache memory 308, doing so typically involves a scheme or policy for determining how to de-allocate resources from I/O filter 306 or other application and re-allocate the resources to the new application (e.g., new VM 302-4). In some embodiments, de-allocating memory from I/O filter 306 involves requesting the memory from I/O filter 306, which may deny the request or identify specific memory for de-allocation. In some embodiments, de-allocating memory from I/O filter 306 involves notifying I/O filter 306 that the reclaimed memory is no longer available. In either case, I/O filter 306 is left with reduced cache, and might have to account for the deallocation (e.g., by reconfiguring the remaining cache or obtaining from main memory data that was previously stored in the deallocated cache). In contrast, the memory used for deallocated cache 402 can simply be used for the new application, without the overhead, latency, and resources of reallocating memory resources. It should be recognized that although the example of allocating a portion of deallocated cache 402 to initiate new VM 302-4 is described above, deallocated cache 402 can be allocated for other purposes, such as increasing the memory allocated to an existing VM.

Although the examples described above refer to VMs, it should be recognized that a VM, more generally, is a virtual computing instance, and the techniques described above can be applied to other types of virtual computing instances, such as containers. A virtual computing instance includes any program, process, or file that emulates an aspect of a computer system. In some embodiments, a container consists of an entire runtime environment for an application (which includes the application and all of its dependencies, libraries, and other binaries) and configuration files needed to run the application, contained into one package. For example, in some embodiments, one or more VMs (e.g., 130 or 302) is another type of virtual computing instance, such as a container. In some embodiments, VMM 124 or hypervisor 304, more generally, is software, firmware, and/or hardware that creates and/or runs one or more virtual computing instances.

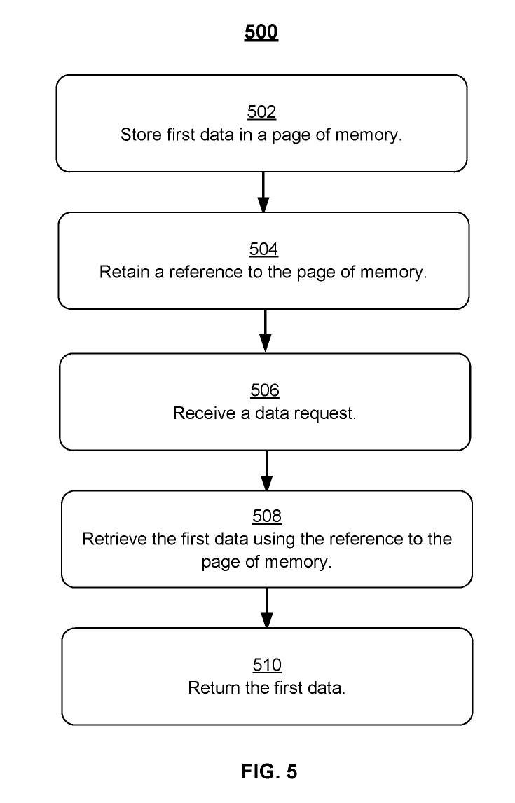

FIG. 5 depicts a flow diagram illustrating an exemplary process 500 for filtering I/O requests in a virtualized computing environment using deallocated memory as cache, according to some embodiments. Process 500 is performed at a computer system (e.g., 100, 300, or 400) including a virtualized computing environment with virtualized components (e.g., virtual computing instances such as VMs 302, VMMs 124, virtual disks 310, containers, etc.). Process 500 provides a fast and memory-efficient technique for caching I/O data (e.g., in an I/O filtering framework). The process reduces the latency associated with servicing I/O requests and reduces memory reserve requirements by using idle memory to cache I/O data. Some operations in process 500 are, optionally, combined, the order of some operations are, optionally, changed, and some operations are, optionally, omitted. Additional operations are optionally added.

At block 502, the computer system stores first data in a page of memory. After the first data is stored in the page of memory, the page of memory is free for allocation to a first memory consumer (e.g., I/O filter 306) and a second memory consumer (e.g., VM 302-4). In some embodiments, the first memory consumer is an I/O filter instantiated in a virtualization layer of the virtualized computing environment. In some embodiments, the first memory consumer stores the first data in the page of memory in response to receiving a first data request (e.g., from a virtual computing instance such as VM 302-1 or VM 302-2) associated with the first data. Optionally, before storing the first data, the first memory consumer (e.g., I/O filter 306) determines whether the data request meets predetermined criteria, and stores the first data in accordance with a determination that the data request meets the predetermined criteria. In some embodiments, storing the first data request in the page of memory includes allocating the page of memory to the first memory consumer, storing the first data in the allocated page of memory, and then releasing the page of memory, where releasing the page of memory makes the page of memory free for allocation to the second memory consumer.

At block 504, the first memory consumer retains a reference to the page of memory.

At block 506, the first memory consumer receives a data request (e.g., a second data request). In some embodiments, the data request of block 506 is received from the same virtual computing instance from which the data request described above with respect to block 502 is received. In some embodiments, the data request of block 506 is received from a different virtual computing instance from which the data request described above with reference to block 502 is received.

At block 508, the first data is retrieved (e.g., by the first memory consumer) using the reference to the page of memory. The first data is retrieved based on the data request in block 506.

At block 510, after retrieving the first data (e.g., in response to retrieving the first data), the first data is returned (e.g., to the virtual computing instance from which the data request in block 506 is received). In some embodiments, before retrieving and returning the first data, the first memory consumer determines whether the data request in block 506 includes a request for data stored in a page of memory to which the first memory consumer has a reference. In such embodiments, the first data is retrieved using the reference and returned in accordance with a determination that the data request in block 506 includes a request for data stored in a page of memory to which the first memory consumer has a reference. Optionally, in accordance with a determination that the data request does not include a request for data stored in a page of memory to which the first memory consumer has a reference, requested data different than the first data is retrieved based on the data request in block 506, and the requested data is then returned (e.g., to the first virtual computing instance from which the data request in block 506 is received).

In some embodiments, after receiving the data request at block 506 (e.g., in response to receiving the data request at block 506), the first memory consumer determines whether the first data stored in the page of memory is valid, and the first data is retrieved using the reference to the page of memory in accordance with a determination that the first data stored in the page of memory is valid. In such embodiments, in accordance with a determination that the first data stored in the page of memory is not valid, the first data is retrieved from a memory location different than the page of memory (e.g., mass storage 106 or virtual disk 310).

In some embodiments, while the first data is stored in the page of memory and while the first memory consumer has the reference to the page of memory, the page of memory is allocated (e.g., by hypervisor 304) to the second memory consumer (e.g., VM 302-4) without notifying the first memory consumer (e.g., I/O filter 306).

Certain embodiments described herein optionally employ various computer-implemented operations involving data stored in computer systems. For example, these operations can require physical manipulation of physical quantities that usually, though not necessarily, take the form of electrical or magnetic signals, where the signals (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a general purpose computer system selectively activated or configured by program code stored in the computer system. In particular, various general purpose machines optionally are used with computer programs written in accordance with the teachings herein, or a more specialized apparatus is constructed to perform the described operations. The various embodiments described herein are optionally practiced with other computer system configurations including handheld devices, microprocessor systems, microprocessor-based or programmable consumer electronics, minicomputers, mainframe computers, and the like.

Yet further, one or more embodiments are optionally implemented as one or more computer programs or as one or more computer programs embodied in one or more transitory or non-transitory computer-readable storage media. The term non-transitory computer-readable storage medium refers to any data storage device that can store data which can thereafter be input to a computer system. The non-transitory computer-readable media can be based on any existing or subsequently developed technology for embodying computer programs in a manner that enables them to be read by a computer system. Examples of non-transitory computer-readable media include a hard drive, network attached storage (NAS), read-only memory, random-access memory, flash-based nonvolatile memory (e.g., a flash memory card or a solid state disk), a CD (Compact Disc) (e.g., CD-ROM, CD-R, CD-RW, etc.), a DVD (Digital Versatile Disc), a magnetic tape, and other optical and non-optical data storage devices. The non-transitory computer-readable media is optionally distributed over a network coupled computer system so that the computer-readable code is stored and executed in a distributed fashion.

Finally, boundaries between various components and operations can be altered, and particular operations are illustrated in the context of specific illustrative configurations. Other allocations of functionality are envisioned and may fall within the scope of the claims. In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” include plural references unless the context clearly dictates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Also, although the terms “first,” “second,” etc. are used in some instances to describe various elements, these elements should not be limited by the terms. These terms are only used to distinguish one element from another. For example, a first data request could be termed a second data request, and, similarly, a second data request could be termed a first data request, without departing from the scope of the various described embodiments.

The above description illustrates various embodiments along with examples of how aspects of particular embodiments are implemented. These examples and embodiments should not be deemed to be the only embodiments, and are presented to illustrate the flexibility and advantages of particular embodiments as defined by the following claims. Other arrangements, embodiments, implementations, and equivalents can be employed without departing from the scope hereof as defined by the claims.

1. A method of filtering input/output (I/O) requests in a virtualized computing environment that includes a first virtual computing instance and a second virtual computing instance, the method comprising:
receiving, by an I/O filter, a first data request, a first data associated with the first data request;
allocating a page of memory to the I/O filter from a free page pool wherein the I/O filter is instantiated in a virtualization layer of the virtualized computing environment wherein the free page pool comprises an ordered list of free pages;
storing by the I/O filter first data associated with the first data request in the page of memory, wherein after the first data associated with the first data request is stored in the page of memory, the page of memory is returned to the free page pool by adding the page of memory to a location within the ordered list of free pages wherein the location increases the likelihood that the page of memory will be valid for use when the I/O filter accesses the page of memory, thereby making the page of memory free for allocation to a first memory consumer and a second memory consumer;
retaining, by the I/O filter, a reference to the page of memory;
receiving, by the I/O filter, a data request from the first virtual computing instance;
retrieving, based on the data request from the first virtual computing instance, the first data associated with the first data request using the reference to the page of memory; and
after retrieving the first data associated with the first data request, returning the first data associated with the first data request to the first virtual computing instance.

2. (canceled)

3. The method of claim 1, further comprising:
before storing the first data associated with the first data request, determining whether the first data request meets predetermined criteria,
wherein the first data associated with the first data request is stored in accordance with a determination that the first data request meets the predetermined criteria.

4-5. (canceled)

6. The method of claim 1, further comprising:
after receiving the data request from the first virtual computing instance:
determining whether the data request from the first virtual computing instance includes a request for data stored in a page of memory to which the I/O filter has a reference, wherein the first data associated with the first data request is retrieved from the page of memory using the reference to the page of memory and returned to the first virtual computing instance in accordance with a determination that the data request from the first virtual computing instance includes a request for data stored in a page of memory to which the I/O filter has a reference; and
in accordance with a determination that the data request from the first virtual computing instance does not include a request for data stored in a page of memory to which the I/O filter has a reference:
retrieving, based on the data request from the first virtual computing instance, requested data different than the first data associated with the first data request from a memory location other than a memory location to which the I/O filter has a reference; and
after retrieving the requested data, returning the requested data to the first virtual computing instance.

7. The method of claim 1, further comprising:
after receiving the data request, determining whether the first data associated with the first data request stored in the page of memory is valid, wherein the first data associated with the first data request is retrieved using the reference to the page of memory in accordance with a determination that the first data associated with the first data request stored in the page of memory is valid; and
in accordance with a determination that the first data associated with the first data request stored in the page of memory is not valid, retrieving the first data associated with the first data request from a memory location different than the page of memory.

8. The method of claim 1, further comprising:
while the first data associated with the first data request is stored in the page of memory and while the I/O filter has the reference to the page of memory, allocating the page of memory to the second memory consumer without notifying the I/O filter.

9. A non-transitory computer-readable storage medium storing one or more programs configured to be executed by one or more processors for filtering input/output (I/O) requests in a virtualized computing environment that includes a first virtual computing instance and a second virtual computing instance, the one or more programs including instructions for:
receiving, by an I/O filter, a first data request, a first data associated with the first data request;
allocating a page of memory to the I/O filter from a free page pool wherein the I/O filter is instantiated in a virtualization layer of the virtualized computing environment wherein the free page pool comprises an ordered list of free pages;
storing by the I/O filter first data associated with the first data request in the page of memory, wherein after the first data associated with the first data request is stored in the page of memory, the page of memory is returned to the free page pool by adding the page of memory to a location within the ordered list of free pages wherein the location increases the likelihood that the page of memory will be valid for use when the I/O filter accesses the page of memory, thereby making the page of memory free for allocation to a first memory consumer and a second memory consumer;
retaining, by the I/O filter, a reference to the page of memory;
receiving, by the I/O filter, a data request from the first virtual computing instance;
retrieving, based on the data request from the first virtual computing instance, the first data associated with the first data request using the reference to the page of memory; and
after retrieving the first data associated with the first data request, returning the first data associated with the first data request to the first virtual computing instance.

10. (canceled)

11. The non-transitory computer-readable storage medium of claim 9, the one or more programs further including instructions for:
before storing the first data associated with the first data request, determining whether the first data request meets predetermined criteria,
wherein the first data associated with the first data request is stored in accordance with a determination that the first data request meets the predetermined criteria.

12-13. (canceled)

14. The non-transitory computer-readable storage medium of claim 9, the one or more programs further including instructions for:
after receiving the data request from the first virtual computing instance:
determining whether the data request from the first virtual computing instance includes a request for data stored in a page of memory to which the I/O filter has a reference, wherein the first data associated with the first data request is retrieved from the page of memory using the reference to the page of memory and returned to the first virtual computing instance in accordance with a determination that the data request from the first virtual computing instance includes a request for data stored in a page of memory to which the I/O filter has a reference; and
in accordance with a determination that the data request from the first virtual computing instance does not include a request for data stored in a page of memory to which the I/O filter has a reference:
retrieving, based on the data request from the first virtual computing instance, requested data different than the first data associated with the first data request from a memory location other than a memory location to which the I/O filter has a reference; and
after retrieving the requested data, returning the requested data to the first virtual computing instance.

15. The non-transitory computer-readable storage medium of claim 9, the one or more programs further including instructions for:
after receiving the data request, determining whether the first data associated with the first data request stored in the page of memory is valid, wherein the first data associated with the first data request is retrieved using the reference to the page of memory in accordance with a determination that the first data associated with the first data request stored in the page of memory is valid; and
in accordance with a determination that the first data associated with the first data request stored in the page of memory is not valid, retrieving the first data associated with the first data request from a memory location different than the page of memory.

16. The non-transitory computer-readable storage medium of claim 9, the one or more programs further including instructions for:
while the first data associated with the first data request is stored in the page of memory and while the I/O filter has the reference to the page of memory, allocating the page of memory to the second memory consumer without notifying the I/O filter.

17. A computer system, comprising:
one or more processors; and
memory storing one or more programs configured to be executed by the one or more processors for filtering input/output (I/O) requests in a virtualized computing environment that includes a first virtual computing instance and a second virtual computing instance, the one or more programs including instructions for:
receiving, by an I/O filter, a first data request, a first data associated with the first data request;
allocating a page of memory to the I/O filter from a free page pool wherein the I/O filter is instantiated in a virtualization layer of the virtualized computing environment wherein the free page pool comprises an ordered list of free pages;
storing by the I/O filter first data associated with the first data request in the page of memory, wherein after the first data associated with the first data request is stored in the page of memory, the page of memory is returned to the free page pool by adding the page of memory to a location within the ordered list of free pages wherein the location increases the likelihood that the page of memory will be valid for use when the I/O filter accesses the page of memory, thereby making the page of memory free for allocation to a first memory consumer and a second memory consumer;
retaining, by the I/O filter, a reference to the page of memory;
receiving, by the I/O filter, a data request from the first virtual computing instance;
retrieving, based on the data request from the first virtual computing instance, the first data associated with the first data request using the reference to the page of memory; and
after retrieving the first data associated with the first data request, returning the first data associated with the first data request to the first virtual computing instance.

18. (canceled)

19. The computer system of claim 17, the one or more programs further including instructions for:
before storing the first data associated with the first data request, determining whether the first data request meets predetermined criteria,
wherein the first data associated with the first data request is stored in accordance with a determination that the first data request meets the predetermined criteria.

20-21. (canceled)

22. The computer system of claim 17, the one or more programs further including instructions for:
after receiving the data request from the first virtual computing instance:
determining whether the data request from the first virtual computing instance includes a request for data stored in a page of memory to which the I/O filter has a reference, wherein the first data associated with the first data request is retrieved from the page of memory using the reference to the page of memory and returned to the first virtual computing instance in accordance with a determination that the data request from the first virtual computing instance includes a request for data stored in a page of memory to which the I/O filter has a reference; and
in accordance with a determination that the data request from the first virtual computing instance does not include a request for data stored in a page of memory to which the I/O filter has a reference:
retrieving, based on the data request from the first virtual computing instance, requested data different than the first data associated with the first data request from a memory location other than a memory location to which the I/O filter has a reference; and
after retrieving the requested data, returning the requested data to the first virtual computing instance.

23. The computer system of claim 17, the one or more programs further including instructions for:
after receiving the data request from the first virtual computing instance, determining whether the first data associated with the first data request stored in the page of memory is valid, wherein the first data associated with the first data request is retrieved using the reference to the page of memory in accordance with a determination that the first data associated with the first data request stored in the page of memory is valid; and
in accordance with a determination that the first data associated with the first data request stored in the page of memory is not valid, retrieving the first data associated with the first data request from a memory location different than the page of memory.

24. The computer system of claim 17, the one or more programs further including instructions for:
while the first data associated with the first data request is stored in the page of memory and while the I/O filter has the reference to the page of memory, allocating the page of memory to the second memory consumer without notifying the I/O filter.

25. The method of claim 1 wherein the list of free pages is an ordered list and the position within the list of free pages is the tail of the list of free pages.

26. The non-transitory computer-readable storage medium of claim 9 wherein the list of free pages is an ordered list and the position within the list of free pages is the tail of the list of free pages.

27. The computer system of claim 17 wherein the list of free pages is an ordered list and the position within the list of free pages is the tail of the list of free pages.
